(19) United States
(12) Patent Application Publication
(10) Pub. No.: US 2016/0334598 A1
(43) Pub. Date: Nov. 17, 2016

(54) THERMALLY COMPENSATED MOUNTING ASSEMBLY WITH AN ELEMENT WHICH IS HELD WITH INVARIANT FORCES

(71) Applicant: JENOPTIK OPTICAL SYSTEMS GMBH, Jena (DE)

(72) Inventor: Torsten ERBE, Jena (DE)

(73) Assignee: JENOPTIK OPTICAL SYSTEMS GMBH, Jena (DE)

(21) Appl. No.: 15/106,712

(22) PCT Filed: Dec. 17, 2014
(86) PCT No.: PCT/DE2014/100455

§ 371 Date: Jun. 20, 2016

(30) Foreign Application Priority Data
Dec. 20, 2013 (DE) 10 2013 114 709.7

(51) Int. Cl. G02B 7/02

(52) U.S. Cl. CPC G02B 7/028

(57) ABSTRACT

Thermally compensated mounting assembly with a monolithic mounting element and with a rotationally symmetrical element mounted therein, wherein the mounting element is divided into a mounting ring with an axis of symmetry and a plurality of elastic connection arms via which the mounted element is held in the mounting element. The connection arms have at least one portion which extends in axial direction of the axis of symmetry. A compensation ring contacts all of the connection arms inside these portions coaxial to the mounting ring. The compensation ring is advantageously made from the same material as the mounted element and completely absorbs the restoring forces occurring as a result of the temperature-dependent deformation of the connection arms due to a different expansion of the mounting element and of the mounted element so that invariant forces act on the connection points between the connection arms and the mounted element.

### RELATED APPLICATIONS

The present application is a U.S. National Stage application of International PCT Application No. PCT/DE2014/100455 filed on Dec. 17, 2014 which claims priority benefit of German Application No. DE 10 2013 114 709.7 filed on Dec. 20, 2013, the contents of each are incorporated by reference in their entirety.

### FIELD OF THE INVENTION

The invention is directed to a thermally compensated mounting assembly with a mounting formed by a monolithic mounting element and with a rotationally symmetrical element mounted therein, wherein the mounting element and the mounted element are made from a material with expansion coefficients which differ from one another. The need for mounting assemblies of this type exists particularly in optical device engineering; therefore, the prior art is defined by generic mounting assemblies in which the mounted element is an optical element. Such a generic assembly is known from Patent EP 1 904 348 B 1.

### BACKGROUND OF THE INVENTION

Basically, mounts for optical elements are constructed based on requirements for imaging quality and the given conditions of transport, storage and use of the optical system of which the mounted optical element forms a component part. Particularly at issue are anticipated shock loads, possible temperature fluctuations during transport, storage and use, and influences of radiation energy and radiation spectrum during use. These stresses notwithstanding, the optical element must be held in the mount in a defined position durably and under low tension.

In order to satisfy the aforementioned requirements, a mounting assembly must allow a radial expansion compensation between the material of the mount and the material of the optical element over a predetermined temperature range. Mounting assemblies of this type are referred to as thermally compensated.

The mount is commonly constructed as a mounting element which is formed by a monolithic rotationally symmetrical base body which is divided into a rigid mounting ring and a plurality of elastic connection arms via which an optical element is connected to the mounting ring directly or indirectly via an auxiliary mount. The elastic connection arms are connected to the mounting ring via at least one flexure bearing and are directly or indirectly connected to the mounted element via a free end. They compensate for radially variable expansion of the optical element and mount by deforming in a reversible manner, whereby a reaction force is brought about which counteracts the deformation and acts on the optical element at connection points between the connection arms and the optical element. Through a targeted selection of material for the mounting element and constructional implementation of the connection arms such that these connection arms are radially compliant or through special steps for configuring the optical element which are intended to prevent operative reaction forces from leading to stresses in the optically active regions, it has been attempted in the prior art to minimize the effect of differential expansion or to shift the location in which the differential expansions operate.

Laid Open Application DE 10 2006 060 088 A1 discloses an optical assembly with a monolithic rotationally symmetrical mounting element forming a mounting ring (referred to in the cited reference as “holder”) at which are formed along the inner circumferential surface three elastic connection arms (referred to in the cited reference as “webs”) which are integrally connected to the mounting ring. The connection arms are formed as flexural elements which medially and tangentially contact an optical element, and the ends of these flexural elements transition into the mounting ring. Because of the radial elastic compliance of the tangentially contacting flexural elements, different thermal expansions between the optical element and the mounting element can be compensated and the optical element is held under low tension within a given temperature range. The optical element is held so as to be constantly centered. In the basic state of the optical assembly at normal temperature, the flexural elements are relaxed. When there is a change in temperature, they are increasingly tensioned radially so that an increasingly larger reaction force, which presents as a compressive force or a tensile force depending on the direction of the reaction force, acts on the connection points in radial direction.

An optical arrangement known from DE 10 2010 008 756 A1 also has a monolithic mounting element and a rotationally symmetrical optical element held therein via three elastic connection arms (referred to in the cited reference as “spring leg arrangements”). The connection arms are formed in each instance by two parallel spring legs, one end of each of the parallel spring legs transitions into a mounting ring (referred to in the cited reference as “outer mount region”) and the other ends terminate in a contact foot to which the optical element is fixed by gluing or soldering. The two parallel spring legs also act as flexural elements in this case and are arranged so as to be spaced apart from one another in direction of their compliance, i.e., perpendicular to the optical axis of the optical element, the gap therebetween being small in proportion to their length. From the point of view of the optical element, they extend along a concave line of curvature. During a radial expansion of the optical element, this optical element exerts radially acting forces on the contact feet, which results in the deflection of the parallel spring legs in a plane perpendicular to the optical axis. In contrast to a simple spring leg which is fixed on one side, there is no bending moment in the region of contact with the optical element, which would be explained by the fact that the spring leg arrangement itself generates a moment in the contact region which counteracts the torque exerted by the optical element, as a result of which the contact foot can only execute a translational movement.

Therefore, the parallel spring legs are increasingly tensioned as the temperature difference increases relative to normal temperature, so that an increasingly greater reaction force acts on the connection points in radial direction, presenting a compressive force or a tensile force depending on the direction of the reaction force.

The not-prior-published DE 10 2013 109 185 B3 discloses an optical assembly comprising a rotationally symmetrical optical element and a monolithic mounting element (referred to in the cited reference as “mount”) having a mounting ring and at least three connection arms (referred to in the cited reference as “connection units”) by which the optical element is connected to the mounting ring. The connection arms comprise three interconnected couplers which have certain length ratios with respect to one another and are connected to one another and to the mounting ring via flexure bearings.

The flexure bearings are elastically deformed by the deflection of the connection arms so as to cause restoring forces in the flexure bearings which cooperate through flow of force to bring about a reaction force on the optical element in each instance.

The solutions of the above-cited publications have in common that an optical element mounted in a monolithic mounting element is connected to a mounting ring via elastic connection arms in order to compensate temperature-dependent differences in expansion between the material of the optical element and the material of the mounting element. However, contingent upon the different expansion, reaction forces generated at the connection points act on the optical element. These reaction forces can lead to stresses or to changes in tension in the optical element and, therefore, alter the imaging characteristics of the optical element.

The object of the not-prior-published DE 10 2013 110 750 B3 is to at least partially compensate these reaction forces occurring at the connection points in order to keep the optical imaging quality constant over a given temperature range.

The thermally compensated mounting assembly described here and referred to in the above-cited reference as “optical assembly” is based on the idea of associating compensation elements with the connection arms such as those described in the three publications cited above, for example. Correspondingly, the quantity of compensation elements must be equal to the quantity of connection arms. The compensation elements comprise in each instance an expansion body with a longitudinal axis and a spring element acting in direction of the longitudinal axis. The connection arms and the spring elements are arranged relative to one another in such a way that they are relaxed at one of the threshold temperatures of the temperature range so that the reaction force acts in the same direction over the entire temperature range. The expansion bodies and the spring elements are configured in such a way that the compensation elements in each instance cause a temperature-dependent compensating force which brings about in each instance a counterforce at the connection points between a mounted optical element and the connection arm, which counterforce counteracts the reaction force.

Solutions according to the above-cited not-prior-published DE 10 2013 110 750 B3 are advantageously applicable to mounting elements which have a comparatively small number of connection arms, since there is one compensation element provided for every connection arm, and in which the connection arms extend in a plane perpendicular to an axis of symmetry or center axis of the mounting element. The plane must lie within the mounting element so that a compensating force acting in this plane can be generated by the compensation elements. The compensation elements can then be supported in the mounting ring such that the compensating force brought about by them acts in this plane.

The idea of adding compensation elements according to the above-cited, not-prior-published DE 10 2013 110 750 B3 cannot be advantageously applied to mounting elements in which the connection arms do not extend exclusively in a plane but rather, at least along a portion, in axial direction of the mounting element such as the mounting elements known from the above-cited EP 1 094 348 B 1.

The above-cited EP 1 094 348 B1 describes a monolithic mounting element (referred to in the above-cited reference as “lens mount”) which is formed at one end as closed mounting ring (referred to in the above-cited reference as “ring”) and, at the second end thereof, the closed ring shape is interrupted by a plurality of slots extending in axial direction. This means that this mounting element also is produced in a monolithic manner from a rotationally symmetrical base body. In contrast to the solutions described above, a larger quantity of connection arms, e.g., 24 according to the drawing, is advantageous. These connection arms extend between the mounting ring and the optical element along a portion in axial direction of the mounting element. The free ends engage radially in an annular groove formed at the circumferential surface of the lens. In this case, as also in the solutions described above, with the exception of a solution according to the above-cited, not-prior-published DE 10 2013 110 750 B3, restoring forces act on the mounted lens in a temperature-dependent manner depending on the deformation of the connection arms.

A mount for an optical element is known from U.S. Pat. No. 4,850,674 A. The mount is made, inter alia, from a slotted ring, e.g., of aluminum, and, as a result of slits within the meaning of the invention, the ring forms a plurality of elastic connection arms which are clamped in on one side, the optical element being held between the free ends thereof. A ring is arranged so as to surround the free ends of these connection arms for temperature compensation.

It is the object of the invention to provide a thermally compensated mounting assembly with a monolithic mounting element and a mounted element in which the mounted element is held, independent of temperature, with an invariant holding force which advantageously compensates only the weight force of the mounted element.

This object is met for a mounting assembly according to claim 1.

Advantageous embodiments are indicated in the subclaims.

### BRIEF DESCRIPTION OF THE DRAWINGS

A thermally compensated mounting assembly according to the invention will be described more fully in the following in various embodiment examples with reference to the drawings. In the drawings:

FIG. 1 is a section view through a first construction of a mounting assembly;

FIG. 2 is a section view through a second construction of a mounting assembly;

FIG. 3 is a section view through a third construction of a mounting assembly;

FIG. 4 is a section view through a fourth construction of a mounting assembly;

FIG. 5 is a section view through a fifth construction of a mounting assembly;

FIG. 6a is a side view of a sixth construction of a mounting element; and

FIG. 6b is a section view through a construction of a mounting assembly according to FIG. 6a.

### DESCRIPTION OF THE EMBODIMENTS

All of the embodiments of a mounting assembly according to the invention basically include a monolithic mounting element 1 which is made of a material with a first expansion coefficient α₁, a rotationally symmetrical element 2 which is mounted therein and which is made of a material with a second expansion coefficient α₂ and a compensation ring 3 made of a material with a third expansion coefficient α₃. The expenditure for a mounting assembly of this type is only reasonable if the first expansion coefficient α₁ is not equal to the second expansion coefficient α₂. Only with regard to the arrangement of the compensation ring 3 is it important whether the first expansion coefficient α₁ is greater than or less than the second expansion coefficient α₂. The mounting element 1 is divided into a mounting ring 1.1 with an axis of symmetry 1.0 and a plurality of elastic connection arms 1.2, e.g., by means of a separating process or machining process. The connection arms 1.2 are connected to a mounting ring 1.1 in each instance via at least one flexure bearing 1.2.1 and have a free end 1.2.2 via which they are connected to the mounted element 2.

It is necessary that the connection arms 1.2 have a portion 1.2.3 in which they extend in axial direction of the axis of symmetry 1.0 of the mounting ring 1.1 such that the compensation ring 3 can be arranged coaxial to the mounting ring 1.1 so as to contact all of the connection arms 1.2. The expansion coefficient of the material of the compensation ring 3, i.e., the third expansion coefficient α₃, is compulsorily not equal to the expansion coefficient of the mounting element 1, i.e., the first expansion coefficient α₁. Its amount is between the first expansion coefficient α₁ and the second expansion coefficient α₂, preferably close to or equal to the second expansion coefficient α₂.

A great many mounting assemblies known from the prior art which have monolithic mounting elements 1 in which a mounted rotationally symmetrical element 2 is held between elastic connection arms 1.2 to compensate differences in expansion between the material of the mounted element 2 and material of the mounting element 1 can be improved by adding a compensation ring 3. The restoring force which changes with the temperature and which is generated in the connection arms 1.2 through deformation is compensated by the compensation ring 3 so that a constant holding force acts on the mounted element 2, which holding force is preferably only great enough to compensate the weight force of the mounted element 2.

In mounting elements 1 with connection arms 1.2 which already have a portion 1.2.3 extending in axial direction of the axis of symmetry 1.0 of the mounting ring 1.1, the mounting ring 1.1 can be arranged so as to surround the connection arms 1.2 or so as to be enclosed by the connection arms 1.2 coaxial to the axis of symmetry 1.0 without needing to carry out structural changes at the mounting element 1. This hardly has an influence on the manner of functioning of a mounting element 1 of this type such as is known from the above-cited EP 1 094 348 B 1. Only a restoring force which acts on the mounted element 2 and changes along with changes in temperature of the connection arms 1.2 is absorbed by the compensation ring 3 so that a holding force occurring at nominal temperature is maintained constant and is accordingly temperature-invariant.

In mounting elements 1 with connection arms 1.2 extending only inside a plane radial to the axis of symmetry 1.0 such as are shown, for example, in the above-cited publications DE 10 2006 060 088 A1, DE 10 2010 008 756 A1 or DE 10 2013 109 185 B3, an axial portion 1.2.3 adjoining the connection arms 1.2 at the free end 1.2.2 is formed as a lengthening.

For mounting assemblies in which the first expansion coefficient α₁ is greater than the second expansion coefficient α₂, the compensation ring 3 is arranged so as to surround the connection arms 1.2. The third expansion coefficient α₃ is less than the first expansion coefficient α₁ and greater than or equal to the second expansion coefficient α₂.

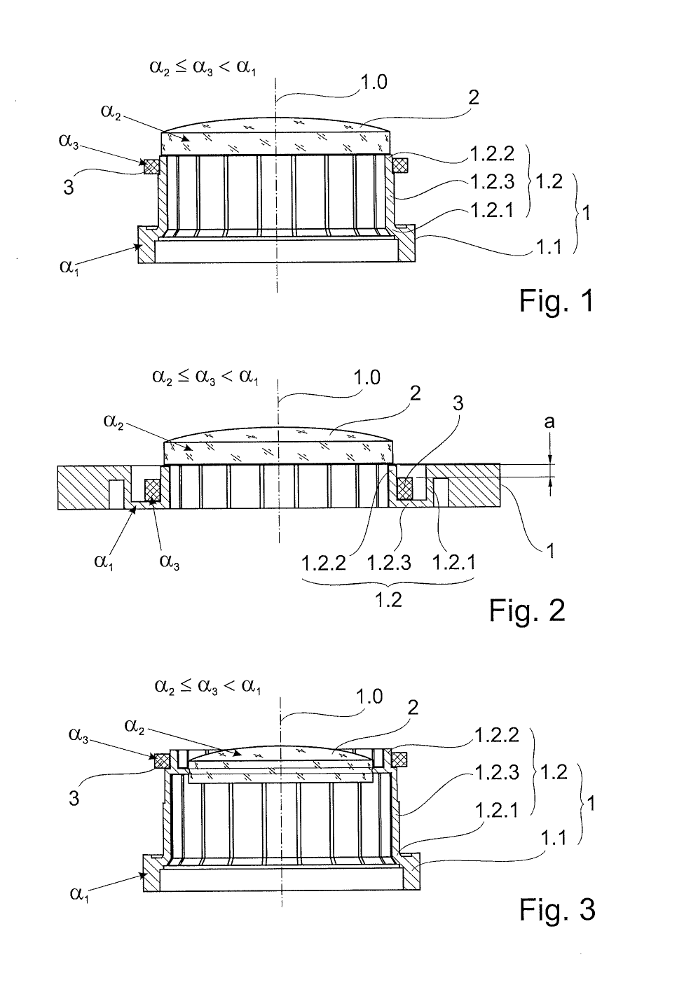

Embodiment examples for this are shown in FIGS. 1, 2, 3 and 6.

In the first embodiment example shown in FIG. 1, the compensation ring 3 surrounds the connection arms 1.2 directly adjoining the free ends 1.2.2 thereof. Accordingly, an indirect, virtually rigid connection is provided between the compensation ring 3 and the mounted element 2. During assembly, the connection arms 1.2 must be preloaded so that at every temperature within a given temperature range for which the mounting assembly is to be thermally compensated they exert a restoring force on the compensation ring 3 that is directed away from the axis of symmetry 1.0. In this case, the compensation ring 3 should be made from the same material as the mounted element 2 so that the outer circumference of the mounted element 2 and the inner circumferential surface of the compensation ring 3 maintain a constant relative position with respect to one another regardless of temperature. Accordingly, the free ends 1.2.2 of the connection arms 1.2 remain in the same relative position with respect to the mounted element 2 and the connection to one another can be produced via a force-free bonding connection, e.g., by means of an adhesive. In this embodiment example, the mounted element 2 and the compensation ring 3 can be produced, e.g., from borosilicate glass, and the mounting element 1 can be produced, e.g., from stainless steel.

The second embodiment example shown in FIG. 2 differs from the first embodiment example principally in that the compensation ring 3 surrounds the connection arms 1.2 at a distance a from the free end 1.2.2. Accordingly, there remains a residual elasticity in the indirect connection between the mounted element 2 and the compensation ring 3 by which small differences in expansion between the compensation ring 3 and the mounted element 2 can be compensated. The temperature compensation can be adjusted via the amount selected for distance a. This is advantageous particularly when the mounted element 2 is made from a material which appears ill-suited for use for the compensation ring 3. In this case, the material of the mounted element 2 could be silica glass, for example. and the material of the compensation ring 3 could be, e.g., an iron-nickel alloy with low thermal expansion.

The third embodiment example, which is shown in FIG. 3, differs from the two previous embodiment examples in the connection between the connection arms 1.2 and the mounted element 2 which, in this instance, is a frictional clamping connection formed by the free ends 1.2.2 of the connection arms 1.2 engaging in an annular groove formed at the circumference of the mounted element 2. The restoring force brought about through preloading of the connection arms 1.2 causes a constant holding force over the changing temperature range. In this case, as in the first embodiment example, changes in the restoring force are also directly absorbed by the compensation ring 3 which has an indirect, virtually rigid connection to the circumference of the mounted element 2.

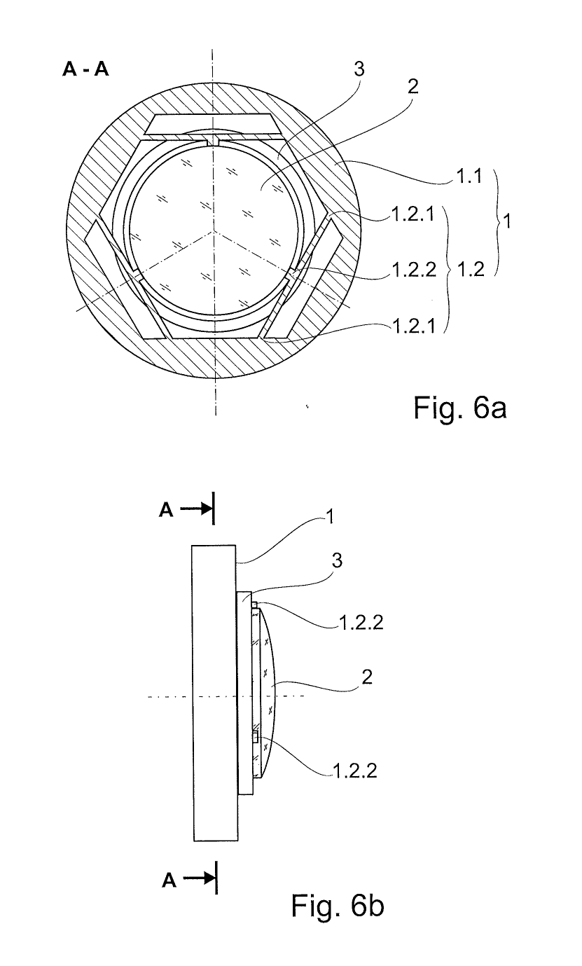

The sixth embodiment example which is shown in FIGS. 6a and 6b shows a mounting assembly such as is known in principle from the above-cited Laid Open Application DE 10 2006 060 088 A1 with a modified mounting element 1. Axial portions 1.2.3 in the form of lengthenings which are surrounded by the compensation ring 3 are formed at the free ends 1.2.2 of the connection arms 1.2. The indirect connection formed in this way between the mounted element 2 and the compensation ring 3 is likewise virtually rigid, so that the same material can advantageously be used for both the compensation ring 3 and the mounted element 2.

For mounting assemblies in which the first expansion coefficient α₁ is less than the second expansion coefficient α₂, the compensation ring 3 is arranged coaxial to the mounting ring 1.1 so as to be surrounded by the connection arms 1.2. The third expansion coefficient α₃ is greater than the first expansion coefficient α₁ and less than or equal to the second expansion coefficient α₂.

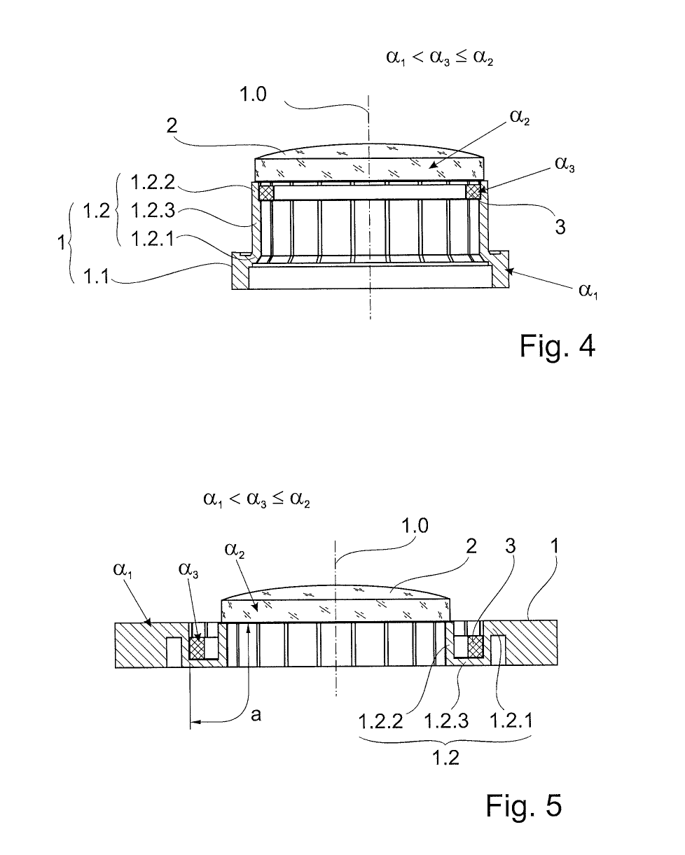

Embodiment examples for this are shown in FIGS. 4 and 5.

The fourth embodiment example which is shown in FIG. 4 operates in a manner identical to the first embodiment example. The compensation ring 3 is merely arranged so as to contact the connection arms 1.2 on the inside and not on the outside, since the expansion ratios are reversed in this case. In this embodiment example, the mounted element 2 and the compensation ring 3 can be produced, e.g., from silica glass and the mounting element 1 can be produced, e.g., from aluminum.

The fifth embodiment example which is shown in FIG. 5 operates in a manner identical to the second embodiment example. The compensation ring 3 is merely arranged so as to contact the connection arms 1.2 on the inside and not on the outside, since the expansion ratios are reversed in this case. The distance a of the compensation ring 3 from the free end 1.2.2 along the connection arm 1.2 is longer in this case, so that a greater elasticity is maintained. Accordingly, the temperature compensation can be adjusted via the selected amount of distance a. The material of the element could be, e.g., steel, and the material of the compensation ring 3 could be, e.g., an iron-nickel alloy with low thermal expansion.

With regard to the second embodiment example and the fifth embodiment example, it is a question of the dimensioning of the connection arms 1.2 and of the distances a to compensate expansion differences between the material of the mounted element 2 and the material of the compensation ring 3 in an optimal manner over the given temperature range through a residual elasticity of the connection arms 1.2.

In a seventh embodiment example which is not shown in the drawings, a mounting assembly such as is known from the above-cited patent EP 1 094 348 B1 with a modified mounting element 1 is to be used analogous to the sixth embodiment example. The connection arms 1.2 are preloaded in a direction opposite to that of the sixth embodiment example. The axial portions 1.2.3 in the form of lengthenings which are formed at the free ends 1.2.2 of the connection arms 1.2 surround the compensation ring 3. The indirect connection formed in this way between the mounted element 2 and the compensation ring 3 is likewise virtually rigid, so that the same material can advantageously be used for both the compensation ring 3 and the mounted element 2.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### LIST OF REFERENCE CHARACTERS

1 mounting element

1.0 axis of symmetry (of the mounting ring 1.1)

1.1 mounting ring

1.2 connection arms

1.2.1 flexure bearing

1.2.2 free end (of one of the connection arms 1.2)

1.2.3 portion (at one of the connection arms 1.2)

2 mounted element

3 compensation ring

α₁ first expansion coefficient

α₂ second expansion coefficient

α₃ third expansion coefficient

α distance

What is claimed is:

1. A mounting assembly comprising a monolithic mounting element having a first expansion coefficient, and a rotationally symmetrical element which is mounted within said mounting element and which has a second expansion coefficient, said first expansion coefficient being greater than the second expansion coefficient, said mounting element being divided into a mounting ring with an axis of symmetry and a plurality of elastic connection arms which are connected to the mounting ring in each instance via at least one flexure bearing and having a free end via which they are connected to the mounted element, said connection arms each extending at least along a portion of the axis of symmetry in an axial direction, a compensation ring which contacts all of the connection arms in each instance inside said at least said portion coaxial to the mounting ring, said compensation ring having a third expansion coefficient which is less than the first expansion coefficient and greater than the second expansion coefficient, and said compensation ring being arranged such that it surrounds the connection arms at a distance from the free ends thereof.

2. A mounting assembly comprising a monolithic mounting element having a first expansion coefficient and a rotationally symmetrical element which is mounted within said mounting element and which has a second expansion coefficient, said first expansion coefficient being less than the second expansion coefficient, said mounting element being divided into a mounting ring with an axis of symmetry and a plurality of elastic connection arms which are connected to the mounting ring in each instance via at least one flexure bearing and having a free end via which they are connected to the mounted element, said connection arms each extending at least along a portion of the axis of symmetry in an axial direction, a compensation ring which contacts all of the connection arms in each instance inside said at least said portion coaxial to the mounting ring, said compensation ring having a third expansion coefficient, said third expansion coefficient being greater than the first expansion coefficient and less than the second expansion coefficient, and said connection arms being arranged so as to surround the compensation ring at a distance from the free ends of the connection arms.

3. A mounting assembly comprising a monolithic mounting element having a first expansion coefficient and a rotationally symmetrical element which is mounted within said mounting element and which has a second expansion coefficient, said first expansion coefficient being less than the second expansion coefficient, said mounting element being divided into a mounting ring with an axis of symmetry and a plurality of elastic connection arms which are connected to the mounting ring in each instance via at least one flexure bearing and have a free end via which they are connected to the mounted element, and the said connection arms each extending at least along a portion of the axis of symmetry in an axial direction, a compensation ring which contacts all of the connection arms in each instance inside said at least said portion coaxial to the mounting ring, said compensation ring having a third expansion coefficient which is greater than the first expansion coefficient and less than the second expansion coefficient, and said connection arms are being arranged so as to surround the compensation ring adjoining the free ends of the connection arms.
